(19) United States
(12) Patent Application Publication
(10) Pub. No.: US 2025/0244953 A1
(43) Pub. Date: Jul. 31, 2025

(54) FUSED MULTIPLY ADD OPERATIONS

(71) Applicant: Arm Limited, Cambridge (GB)

(72) Inventors: David Raymond LUTZ, Austin, TX (US); Javier Diaz BRUGUERA, Santiago de Compostela (ES); Harsha VALSARAJU, Austin, TX (US)

(21) Appl. No.: 18/428,115

(22) Filed: Jan. 31, 2024

(51) Int. Cl. G06F 7/523; G06F 7/50

(52) U.S. Cl. CPC G06F 7/523; G06F 7/50

(57) ABSTRACT

A data processing apparatus is provided that performs a fused multiply add operation. Multiplication circuitry multiplies pairs of floating-point multiplication values together to produce unrounded products. Addition circuitry adds a sum of the products to an accumulation value to produce a rounded floating-point result and control circuitry, responsive to a fused multiply add instruction, controls the multiplication circuitry and the addition circuitry to perform the fused multiply add operation. The addition circuitry accesses the accumulation value at a later processing cycle than the multiplication circuitry accesses the pairs of floating-point multiplication values.

### TECHNICAL FIELD

The present disclosure relates to data processing.

### DESCRIPTION

Fused multiply add operations are atomic operations that include a multiplication followed by an addition using the product of the multiplication. Importantly, the entire fused multiply add operation is achieved using a single rounding step, which improves accuracy as compared to a system that firstly performs multiplication, then performs rounding, and then performs the addition.

### SUMMARY

Viewed from a first example configuration, there is provided a data processing apparatus for performing a fused multiply add operation, the data processing apparatus comprising: multiplication circuitry configured to multiply pairs of floating-point multiplication values together to produce a plurality of unrounded products; addition circuitry configured to add a sum of the plurality of products to an accumulation value to produce a rounded floating-point result; and control circuitry responsive to a fused multiply add instruction to control the multiplication circuitry and the addition circuitry to perform the fused multiply add operation, wherein the addition circuitry is configured to access the accumulation value at a later processing cycle than the multiplication circuitry accesses the pairs of floating-point multiplication values.

Viewed from a second example configuration, there is provided a method of performing a fused multiply add operation comprising: multiplying pairs of floating-point multiplication values together to produce a plurality of unrounded products; adding a sum of the plurality of products to an accumulation value to produce a rounded floating-point result; and responding to a fused multiply add instruction to control multiplication circuitry and addition circuitry to perform the fused multiply add operation, wherein the accumulation value is accessed at a later processing cycle than the pairs of floating-point multiplication values.

Viewed from a third example configuration, there is provided a computer program for controlling a host data processing apparatus to provide an instruction execution environment, the computer program comprising: multiplication program logic configured to multiply pairs of floating-point multiplication values together to produce a plurality of unrounded products; addition program logic configured to add a sum of the plurality of products to an accumulation value to produce a rounded floating-point result; and control program logic responsive to a fused multiply add instruction to control the multiplication program logic and the addition program logic to perform the fused multiply add operation, wherein the addition program logic is configured to access the accumulation value at a later processing cycle than the multiplication program logic accesses the pairs of floating-point multiplication values.

### BRIEF DESCRIPTION OF THE DRAWINGS

The present invention will be described further, by way of example only, with reference to embodiments thereof as illustrated in the accompanying drawings, in which

FIG. 1 illustrates an example of a fused multiply-add instruction FMULADD;

FIG. 2 illustrates, schematically, circuitry for performing the fused multiply add operation shown with respect to FIG. 1;

FIG. 3 illustrates a chaining of fused multiply add instructions that can be used to multiply numerous sets of numbers together and then add all the products;

FIG. 4 shows a detailed layout of circuitry for performing the fused multiply add operation that was schematically illustrated in FIG. 2;

FIG. 5 shows a method of data processing in accordance with some examples in the form of a flowchart; and

FIG. 6 illustrates a simulator implementation that may be used.

### DESCRIPTION OF EXAMPLE EMBODIMENTS

Before discussing the embodiments with reference to the accompanying figures, it is worth considering the nature of floating-point numbers

Floating-point (FP) is a useful way of approximating real numbers using a small number of bits. The IEEE 754-2008 FP standard proposes multiple different formats for FP numbers, but the ones that ARM is concerned with are binary 64 (also known as double precision, or DP), binary 32 (also known as single precision, or SP), and binary 16 (also known as half precision, or HP). The numbers 64, 32, and 16 refer to the number of bits required for each format.

FP numbers are quite similar to the “scientific notation” taught in science classes, where instead of negative two million we'd write −2.0×106. The parts of this number are the sign (in this case negative), the significand (2.0), the base of the exponent (10), and the exponent (6). All of these parts have analogs in FP numbers, although there are differences, the most important of which is that the constituent parts are stored as binary numbers, and the base of the exponent is always 2.

More precisely, FP numbers all consist of a sign bit, some number of biased exponent bits, and some number of fraction bits. In particular, the formats we are interested in consist of the following bits:

| format | sign | exponent | Traction | exponent bias |
|---|---|---|---|---|
| DP [63:0] | 63 | 62:52 (11 bits) | 51:0 (52 bits) | 1023 |
| SP [31:0] | 31 | 30:23 (8 bits) | 22:0 (23 bits) | 127 |
| HP [15:0] | 15 | 14:10 (5 bits) | 9:0 (10 bits) | 15 |

The sign is 1 for negative numbers and 0 for positive numbers. Every number, including zero, has a sign.

The exponent is biased, which means that the true exponent differs from the one stored in the number. For example, biased SP exponents are 8-bits long and range from 0 to 255. Exponents 0 and 255 are special cases, but all other exponents have bias 127, meaning that the true exponent is 127 less than the biased exponent. The smallest biased exponent is 1, which corresponds to a true exponent of −126. The maximum biased exponent is 254, which corresponds to a true exponent of 127. HP and DP exponents work the same way, with the biases indicated in the table above.

SP exponent 255 (or DP exponent 2047, or HP exponent 31) is reserved for infinities and special symbols called NaNs (not a number). Infinities (which can be positive or negative) have a zero fraction. Any number with exponent 255 and a nonzero fraction is a NaN. Infinity provides a saturation value, so it actually means something like “this computation resulted in a number that is bigger than what we can represent in this format.” NaNs are returned for operations that are not mathematically defined on the real numbers, for example dividing zero by zero or taking the square root of a negative number.

Exponent zero, in any of the formats, is reserved for subnormal numbers and zeros. A normal number represents the value:

$$- 1 sign \times \text{.1} fraction \times 2 e$$

where e is the true exponent computed from the biased exponent. The term 1.fraction is called the significand, and the 1 is not stored as part of the FP number, but is instead inferred from the exponent. All exponents except zero and the maximum exponent indicate a significand of the form 1.fraction. The exponent zero indicates a significand of the form 0.fraction, and a true exponent that is equal to 1-bias for the given format. Such a number is called subnormal (historically these numbers were referred to as denormal, but modem usage prefers the term subnormal). Numbers with both exponent and fraction equal to zero are zeros.

The following table has some example numbers in HP format. The entries are in binary, with ‘_’ characters added to increase readability. Notice that the subnormal entry (4th line of the table, with zero exponent) produces a different significand than the normal entry in the preceding line.

| | 5-bit | | | |
|---|---|---|---|---|
| sign | exponent | 10-bit fraction | 11-bit significand | value |
| 0 | 01111 | 00_0000_0000 | 100_0000_0000 | 1.0 × 2⁰ |
| 1 | 01110 | 10_0000_0000 | 110_0000_0000 | −1.1 × 2⁻¹ |
| 0 | 00001 | 10_0000_0000 | 110_0000_0000 | 1.1 × 2⁻¹⁴ |
| 0 | 00000 | 10_0000_0000 | 010_0000_0000 | 0.1 − 2⁻¹⁴ |
| 1 | 11111 | 00_0000_0000 | | −infinity |
| 0 | 11111 | 00_1111_0011 | | NaN |

A large part of the complexity of FP implementation is due to subnormals, therefore they are often handled by microcode or software. All recent ARM parts (anything with Cortex in the name) handle subnormals in hardware, speeding up these operations by a factor of 10 to 100 compared to a software or microcode implementation.

The FP way of handling signs is called sign-magnitude, and it is different from the usual way integers are stored in the computer (two's complement). In sign-magnitude representation, the positive and negative versions of the same number differ only in the sign bit. A 4-bit sign-magnitude integer, consisting of a sign bit and 3 significand bits, would represent plus and minus one as:

$$\begin{matrix}+ 1 = 0001 \\ - 1 = 1001\end{matrix}$$

In two's complement representation, an n-bit integer i is represented by the low order n bits of the binary n+1-bit value 2n+i, so a 4-bit two's complement integer would represent plus and minus one as:

$$\begin{matrix}+ 1 = 0001 \\ - 1 = 1111\end{matrix}$$

The two's complement format is practically universal for signed integers because it simplifies computer arithmetic.

A fixed-point number looks exactly like an integer, but actually represents a value that has a certain number of fractional bits. Sensor data is often in fixed-point format, and there is a great deal of fixed-point software that was written before the widespread adoption of FP. Fixed-point numbers are quite tedious to work with because a programmer has to keep track of the “binary point”, i.e. the separator between the integer and fractional parts of the number, and also has to constantly shift the number to keep the bits in the correct place. FP numbers don't have this difficulty, so it is desirable to be able to convert between fixed-point numbers and FP numbers. Being able to do conversions also means that we can still use fixed-point software and data, but we are not limited to fixed-point when writing new software.

Most FP operations are required by the IEEE-754 standard to be computed as if the operation were done with unbounded range and precision, and then rounded to fit into an FP number. If the computation exactly matches an FP number, then that value is always returned, but usually the computation results in a value that lies between two consecutive floating-point numbers. Rounding is the process of picking which of the two consecutive numbers should be returned.

There are a number of ways of rounding, called rounding modes; six of these are of interest to ARM. These six are:

| mode | change to the truncated value |
|---|---|
| RNE | increment if (L&G)\|(G&S) |
| RNA | increment if G |
| RZ | none |
| RP | increment if positive & (G\|S) |
| RM | increment if negative & (G\|S) |
| RX | set L if G\|S |

The definition doesn't tell us how to round in any practical way. One common implementation is to do the operation, look at the truncated value (i.e. the value that fits into the FP format) as well as all of the remaining bits, and then adjust the truncated value if certain conditions hold. These computations are all based on:
L—(least) the least significant bit of the truncated value
G—(guard) the next most significant bit (i.e. the first bit not included in the truncation)
S—(sticky) the logical OR of all remaining bits that are not part of the truncation

Given these three values and the truncated value, we can always compute the correctly rounded value according to the following table:
mode change to the truncated value
RNE increment if (L&G)I(G&S)
RNA increment if G
RZ none
RP increment if positive & (GIS)
RM increment if negative & (GIS)
RX set L if GIS

For example, consider multiplying two 4-bit significands, and then rounding to a 4-bit significand.
sig1=1011 (decimal 11)
sig2=0111 (decimal 7) multiplying yields

$$sig 1 \times sig 2 = 100 \_ 100 ( decimal 77 )$$

The least significant bit of the truncated 4-bit result is labeled L, the next bit G, and S is the logical OR of the remaining bits labeled s (i.e. S=0 1=1). To round, we adjust our 4-bit result (1001) according to the rounding mode and the computation in the table above. So for instance in RNA rounding, G is set so we return 1001+1=1010. For RX rounding G|S is true so we set L to 1 (it's already 1, so in this case nothing changes) and return 1001.

If we convert an FP number to integer or fixed-point we also have to round. The concept is basically the same as FP rounding. An FP number that happens to be an integer always rounds to that integer. All other FP numbers lie between two consecutive integers, and rounding dictates which integer is returned. Unfortunately the rounding logic for integers is somewhat harder because of the differences between two's complement and sign-magnitude form. Incrementing a sign-magnitude number always increases the magnitude, so the incremented number is farther away from zero. The same thing happens for positive two's complement numbers, but negative two's complement numbers become closer to zero when incremented. This means that the rounding logic has to change based on whether the integer is positive or negative. It also means we have to be careful in picking the base value (the value which will be incremented or not). For positive integers, that value is just the truncated FP significand, so 1.37 will have a base value of 1, and a result of either 1 or 2. For negative integers, we again truncate the significand and take the one's complement of the result (one's complement is the original number with all bits inverted), −1.37 is truncated to 1 and then inverted, giving a base value of −2. Everything then works out since we want our result to be either −2 or (when incremented) −1.

To further complicate things, our method of conversion requires some computation to find L, G, and S for negative integers. Correct rounding would require us to complete the two's complement process (invert and add 1) and then compute L, G, and S, but adding that 1 is slow compared to just inverting. Ideally we would like to compute the actual L, G, and S from the original shifted input (i.e., from the input before we've done anything about signs. So the floating-point 1.37 or −1.37 would both be right shifted to the integer 1).

Let L0, G0, and S0 be the least significant bit (lsb), guard and sticky before inverting, and let Li, Gi, and Si be lsb, guard and sticky after inverting, and finally let L, G, and S be the lsb, guard and sticky after inverting and adding 1.

If S0 is zero, then the bits contributing to Si are all ones, and hence S (obtained by adding 1 to those Si bits) is also zero. If S0 is nonzero, then Si is not all ones, and hence S is nonzero. So in all cases S0=S.

If G0 is zero, then Gi is 1, and G is also one except for the case when there is a carry-in from the S bits, which only happens when S0 is zero. If G0 is 1, then Gi is zero, and again G is also zero except for the case where there is a carry-in from the S bits, which only happens when S0 is zero. So G=G0\hat{ }S0. By very similar logic, L=L0\hat{ } (G0|S0).

Now that we have L, G, and S for both negative and positive integers, we can come up with our rounding rules:

| mode | change to a positive value | change to a negative value |
|---|---|---|
| RNE | increment if (L&G)\|(G&S) | increment if (L&G)\|(G&S) |
| RNA | increment if G | increment if (G&S) |
| RZ | none | increment if (G\|S) |
| RP | increment if (G\|S) | increment if (G\|S) |
| RM | none | none |
| RX | set L if G\|S | set L if G\|S |

Fixed-point numbers round exactly the same way as integers. The rules for unsigned conversions (to integer or fixed-point) are the same as the rules for positive conversions.

A faster way to do rounding is to inject a rounding constant as part of the significand addition that is part of almost every FP operation. To see how this works, consider adding numbers in dollars and cents and then rounding to dollars. If we add
$1.27
+$2.35
$3.62

We see that the sum $3.62 is closer to $4 than to $3, so either of the round-to-nearest modes should return $4. If we represented the numbers in binary, we could achieve the same result using the L, G, S method from the last section. But suppose we just add fifty cents and then truncate the result?
1.27
+2.35
+0.50 (rounding injection)
4.12 If we just returned the dollar amount ($4) from our sum ($4.12), then we have correctly rounded using RNA rounding mode. If we added $0.99 instead of $0.50, then we would correctly round using RP rounding. RNE is slightly more complicated: we add $0.50, truncate, and then look at the remaining cents. If the cents remaining are nonzero, then the truncated result is correct. If there are zero cents remaining, then we were exactly in between two dollar amounts before the injection, so we pick the even dollar amount. For binary FP this amounts to setting the least significant bit of the dollar amount to zero.

Adding three numbers is only slightly slower than adding two numbers, so we get the rounded result much more quickly by using injection rounding than if we added two significands, examined L, G, and S, and then incremented our result according to the rounding mode.

For FP, the rounding injection is one of three different values, values which depend on the rounding mode and (sometimes) the sign of the result.
Both RNA and RNE require us to inject a 1 at the G position (this is like adding $0.50 in our dollars and cents example).
RP and RM rounding depends on the sign as well as the mode. RP rounds positive results up (increases the magnitude of the significand towards positive infinity), but truncates negative results (picking the significand that is closer to positive infinity). Similarly RM rounds negative results up (increasing the magnitude of the significand toward negative infinity), but truncates positive results (picking the significand that is closer to negative infinity). Thus we split RM and RP into two cases: round up (RU) when the sign matches the rounding direction, and truncation (RZ) when the sign differs from the rounding injection. For RU cases we inject a 1 at the G-bit location and at every location that contributes logically to S (this is like adding $0.99 in our dollars and cents example).
For RZ and RX modes, and for RP and RM modes that reduce to RZ mode, we inject zeros.

For most of the rounding modes, adding the rounding injection and then truncating gives the correctly rounded result. The two exceptions are RNE and RX, which require us to examine G and S after the addition. For RNE, we set L to 0 if G and S are both zero. For RX we set L to 1 if G or S are nonzero.

It's tempting to think of FP numbers as being just like real numbers, but they are fundamentally different, even for the most basic properties:
1. They are not associative. For example, in SP we can add 3 numbers and return 1 million or zero, perhaps not what people think of as a rounding error:

$$\begin{matrix}( 245 + - 245 ) + 220 = 220 \\ 245 + ( - 245 + 220 ) = 0\end{matrix}$$

2. They don't obey the distributive laws. Again in SP:

$$\begin{matrix}3 , 000 , 0001 * ( 4.00001 + 5.00001 ) = 0 \times 4 bcdfe 83 \\ ( 3 , 000 , 001 * 4.00001 ) + ( 3 , 000 , 001 * 5.00001 ) = 0 \times 4 bcdfe 82\end{matrix}$$

and things get even worse in the presence of overflow:

$$\begin{matrix}250 * ( 278 - 277 ) = 2127 \\ ( 250 * 278 ) - ( 250 * 277 ) = infinity\end{matrix}$$

3. For ARM, they aren't even commutative unless we are in default NaN mode (a mode that converts all NaNs to a single NaN), because in general nanA+nanB=nanB+nanA. Numeric adds and multiplies are commutative.
4. Because of IEEE NaN rules, there are no multiplicative or additive identities. One and zero work as identities for numeric values.

One useful way to think of FP numbers is to consider them to be very long fixed-point numbers in which at most a few (53 for DP) consecutive bits can be nonzero. For example, non-infinite DP numbers can have the first bit of the significand in any of 2046 places, and that first bit is followed by 52 other significand bits, and there is a sign bit, so any finite DP number can be represented as a 2046+52+1=2099-bit fixed point number. Examined this way it becomes very obvious that adding two FP numbers does not, in general, result in another FP number: the result of the addition has to be rounded so that it becomes an FP number.

The standard allows implementations to choose when to signal underflow, either before or after rounding. ARM specifies underflow before rounding, which leads to problems when we implement injection rounding because there is no unrounded value. We generally solve this by a side computation: detecting minimum normal result with additional logic to determine if it was the rounding increment that brought us to minimum normal.

Flush-to-zero (FZ) mode is not part of the standard. In the ARM implementation, subnormal inputs are treated as signed zeros, and results that are subnormal before rounding are also replaced by signed zeros. As in the underflow computation, injection rounding can be tricky here because we have no unrounded result to work with, but the solution is also the same as we used to detect underflow.

ARM defines a signaling NaN to be an infinite exponent, high-order fraction bit set to zero, and at least one other fraction bit set. A quiet NaN has infinite exponent plus high-order fraction bit set to 1. Quieting a signaling NaN means setting its high-order fraction bit to 1. The default NaN is a quiet NaN with all remaining fraction bits set to zero.

ARM has two NaN modes, “default NaN” and “full compliance”, although both modes are actually fully compliant with the shall part of the standard. In default-NaN mode, the default NaN is the only NaN ever returned by an operation. In “full compliance” mode, the input operands are scanned from left to right, first for signaling NaNs (returning a quieted version of the first one found), and then if no signaling NaNs are found, for quiet NaNs (again returning the first one found).

IEEE formats (DP, SP, HP) plus some of the newer formats.

| format | sign | exponent | | fraction | | exponent bias |
|---|---|---|---|---|---|---|
| DP [63:0] | 63 | 62:52 | (11 bits) | 51:0 | (52 bits) | 1023 |
| SP [31:0] | 31 | 30:23 | (8 bits) | 22:0 | (23 bits) | 127 |
| HP [15:0] | 15 | 14:10 | (5 bits) | 9:0 | (10 bits) | 15 |
| bfloat[15:0] | 15 | 14:7 | (8 bits) | 6:0 | (7 bits) | 127 |
| FP8 1-5-2 [7:0] | 7 | 6:2 | (5 bits) | 1:0 | (2 bits) | 15 |
| FP8 1-4-3 [7:0] | 7 | 6:3 | (4 bits) | 2:0 | (3 bits) | 7 |

So far we continue to follow the IEEE exponent biasing rules, where an n-bit exponent 0<e<2n-1 has bias 2n-1-1 and exponent zero is for subnormals and zeros. For most formats the exponent 2n-1 is for infinities and NaNs, but the 1-4-3 format is likely to use the maximum exponent for biased numerical values.

We propose to use the FP8 formats as storage formats. This does not mean that they can't be used in computations, but that they tend not to be intermediate or final results of computations, just inputs to computations. The most common computation in machine learning is matrix multiplication, where each entry of the product matrix is computed as a sum of many products.

The particular instructions we are considering are a sum of an SP value with four FP8 products, and a sum of an HP value with two FP8 products.

The FP8 inputs can be any combination of the two FP8 formats. An easy way to handle this is to convert any FP8 inputs to a hybrid 1-5-3 format. So how do we convert from 4-bit exponents to 5-bit exponents?

Let e be the true exponent, and let e_4b be the biased 4-bit exponent, and let e_5b be corresponding biased 5-bit exponent. The way biasing works we have e_4b=e+7, and e_5b=e+15. The underlying true exponent e doesn't change, which makes converting from 4 to 5 bit exponents easy: e_4b-7=e_5b-15, or e_5b=e_4b+8.

Adding 8 to a 4-bit exponent doesn't require an adder:

$$assign\_e5b [ 4 : 0 ] = \{ e\_ 4 b [ 3 ] , \sim e\_ 4 b [ 3 ] , e\_ 4 b [ 2 : 0 ] \} ;$$

Converting to a common 5-bit biased exponent involves hardly any gates, just one inverter.

We do have to deal with zero exponents, and for computing shift distances they are best treated as exponent 1 (because biased exponents zero and one represent the same real exponent). Infinities and NaNs are handled outside of the normal exponent computations.

As usual, the product of two numbers with true 5-bit exponents ea and eb has exponent ea+eb. For most of our multipliers the computation is not that simple because the sum of two biased exponents gives an exponent that has twice the bias: ea_5b+eb_5b=ea+15+eb+15=ea+eb+30. Because we are going to convert each product to a fixed point number, it would be convenient to use a 6-bit biased exponent for the sum. By the IEEE exponent biasing convention, a 6-bit biased exponent would have bias 31. We've already shown that the sum of the two biased 5-bit exponents has bias 30, so we can easily get the correct bias by adding a carry-in bit to the sum of the exponents:

$$assign\_e6b [ 5 : 0 ] = ea\_ 5 b [ 4 : 0 ] + eb\_ 5 b [ 4 : 0 ] + 1 ’ b 1 ;$$

The exponent e_6b can then be used for the fast conversion to fixed point.

Before discussing the embodiments with reference to the accompanying figures, the following description of embodiments is provided.

In accordance with one example configuration there is provided a data processing apparatus for performing a fused multiply add operation, the data processing apparatus comprising: multiplication circuitry configured to multiply pairs of floating-point multiplication values together to produce a plurality of unrounded products; addition circuitry configured to add a sum of the plurality of products to an accumulation value to produce a rounded floating-point result; and control circuitry responsive to a fused multiply add instruction to control the multiplication circuitry and the addition circuitry to perform the fused multiply add operation, wherein the addition circuitry is configured to access the accumulation value at a later processing cycle than the multiplication circuitry accesses the pairs of floating-point multiplication values.

The above technique considers the situation in which it is desired to multiple several pairs of floating-point numbers together. The resulting products (unrounded) are then added to an accumulation value and the result is rounded (i.e. at the end rather than at multiple stages of the process). By accessing the accumulation value later than the pairs of floating-point multiplication values are accessed, the length of time for which the accumulation parameter is needed can be reduced. For instance, the accumulation parameter can be provided after the fused multiply add operation has begun, which may allow it to be produced by an operation that might not complete until the fused multiply add operation has started. Furthermore, any storage used for the accumulation parameter can be freed up and therefore not used until necessary

In some examples, the addition circuitry is controlled by the control circuitry to commence processing of the accumulation parameter after the multiplication circuitry has generated the plurality of unrounded products. In these examples, the multiplication part of the fused multiply add can be separated from the addition part (despite the two parts being performed as one atomic operation). This frees up large portions of the circuitry, which can result in power savings or can allow a group of multiple operations to be clustered together and executed efficiently. For instance, for a given fused multiply add operation, either the multiplication circuitry or the addition circuitry may be free, which can therefore be put to no purpose (to save energy) or to another purpose (to efficiently perform a sequence of operations).

In some examples, the unrounded products are fixed-point unrounded products. A fixed-point number is one in which the decimal point is at a fixed location of all numbers. For instance, it might be at digit 4, which would make the number 45898149 equal to 4589.8149 or the number 00000014 equal to 0.0014. This differs from a floating-point number in which the decimal point can be moved on a number-by-number basis. In these examples, addition is performed on the products that are in fixed-point format. This can be achieved by, for instance, converting the result of the products into a fixed-point format.

In some examples, the accumulation value is a floating-point accumulation value. As explained above, a floating-point number has no fixed location for the decimal point. This makes it possible to express numbers over a large range and with large accuracy.

In some examples, the addition circuitry is configured to perform the addition using a scaling factor that indicates how the sum of the plurality of products is to be scaled. By providing a separate scaling factor, it is possible to extend the range of possible numbers that can be expressed by the pairs of floating-point multiplication parameters. In particular, whatever range can be naturally extended to the floating-point numbers can be extended by the scaling factor that enables the number expressed by the bits of the floating-point numbers to be increased or decreased by a particular factor.

In some examples, the fused multiply add instruction is one of a sequence of instructions and the accumulation value is a value generated in response to a preceding instruction in said sequence of instructions. In this way operations can be chained so that the output of one operation is further modified by another operation.

In some examples, the preceding instruction is a preceding fused multiply add instruction. In some situations, it might be desirable for numerous multiplications to be performed and for all of the products of those multiplications to be added together. In these situations, a first fused multiply add operation may be performed for a first set of the multiplications, and the result of that may be provided as the accumulation value to a second fused multiply add operation that takes in a second set of multiplications. It will be appreciated that matrix multiplications are often performed in machine learning and so the present technique might have particular relevance to the field of machine learning.

In some examples, the apparatus comprises: further addition circuitry configured to add the plurality of unrounded products together to generate the sum of the plurality of products. A first addition circuit (previously referred to) can be used to add the sum of products to the accumulation parameter. Meanwhile, a second addition circuit can be used to add the products together to form the sum of products.

In some examples, the addition circuitry is controlled by the control circuitry to commence processing of the accumulation parameter after the further addition circuitry has generated the sum of the plurality of products. The addition process can therefore be split into two parts: one to multiply the products together to produce the sum and another to add the sum to the accumulation parameter. The accumulation parameter may only be processed after the addition of the products has taken place thereby further delaying the time until the accumulation parameter is used.

In some examples, the sum of the plurality of products output by the further addition circuitry is a fixed-point number. As explained above, in a fixed-point number, the decimal point may be at a fixed location. The sum could be generated either as a consequence of the inputs being fixed-point numbers or the sum could be initially produced in a particular format that is converted to a fixed-point number. In either case, the fixed-point number may be converted to another format before being received by the addition circuitry. For instance, the fixed-point number may be converted to a floating-point number (or to a separate significand and exponent) before it is passed to the addition circuitry.

In some examples, the sum of the plurality of products is generated without loss of accuracy. Loss of accuracy can result as a consequence of rounding—either intentional or unintentional due to a limited number of bits being available to store the result of an operation. In these examples, the products are expressed to a particular degree of accuracy and the storage structures used to store the sum of the plurality of products is sufficiently large that regardless of the values of the products, no accuracy is lost during the addition process.

In some examples, the control circuitry is responsive to a sequence of fused multiply add instructions comprising a first fused multiply add instruction and a second fused multiply add instruction to control the multiplication circuitry and the addition circuitry such that the adding circuitry performs an add operation in response to the first fused multiply add instruction in parallel with the multiplication circuitry performing a multiply operation in response to the second fused multiply add instruction. In this way, a series of fused multiply add operations can thereby be ‘dovetailed’ or ‘chained’ together in order to efficiently add together results of a large number of multiplication products.

In some examples, each of the floating-point multiplication values has a width of 8 bits. Small width floating point numbers exist in a number of different formats depending on their application. However, once the sign bit is accounted for, this only leaves seven bits to express both the exponent and the significand. Different applications may therefore wish to give a greater number of bits to expressing the significand (thereby giving more accuracy) or the exponent (thereby increasing the range of numbers that can be expressed). Either the software or the hardware may make it possible to dictate what particular format the FP8 number takes. However, where numbers of different FP8 formats are provided to a single operation, conversion may be performed in order to put the numbers into a consistent format. One application in which FP8 numbers may be used is in machine learning algorithms where a high level of accuracy is not necessarily needed and in which the numbers may have a similar scale to each other (thereby making it possible to use a single scaling factor where particularly large or particularly small numbers need to be expressed).

In some examples, the multiplication circuitry is configured to multiply four pairs of floating-point multiplication values. Four FP8 values can, for instance, be provided within a single 32-bit register. It is therefore possible to express the cross product of four FP8 numbers by another four FP8 numbers by providing a fused multiply add instruction in which the parameters include references to two 32-bit registers and a register that stores the accumulation value.

Particular embodiments will now be described with reference to the figures.

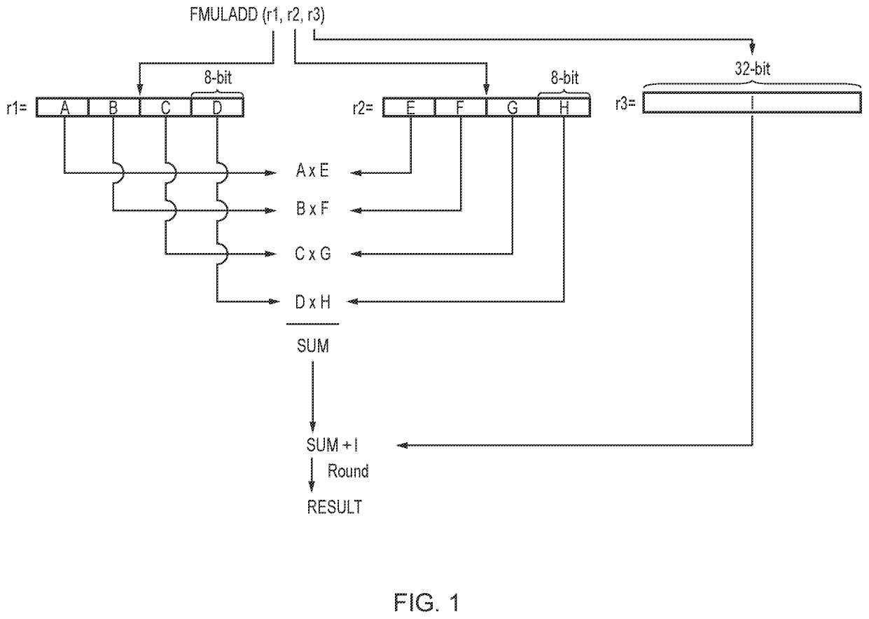

FIG. 1 illustrates an example of a fused multiply-add instruction FMULADD. The instruction comprises three parameters: a first multiplication parameter, a second multiplication parameter, and an accumulation parameter. Each of the multiplication parameters acts as a reference to a location of numbers to be multiplied together. In this example, register r1 points to a first set of 8-bit floating-point numbers and r2 points to a second set of 8-bit floating-point numbers and a cross product is performed between the first set and the second set. For instance, the first element (A) of the first register r1 is multiplied by the first element (E) of the second register r2, the second element (B) of the first register r1 is multiplied by the second element (F) of the second register r2, the third element (C) of the first register r1 is multiplied by the third element (G) of the second register r2 and so on. The resulting products are then added together to form a sum. The accumulation parameter points to a location that acts as both a destination of the resulting calculation and also a source of a parameter to be added to the sum to produce the final result. In this example, the accumulation parameter is a 32-bit floating-point number.

Note that since this is a fused multiply add operation, rounding is only performed once—at the end. In particular it is performed after the accumulation parameter has been added to the sum.

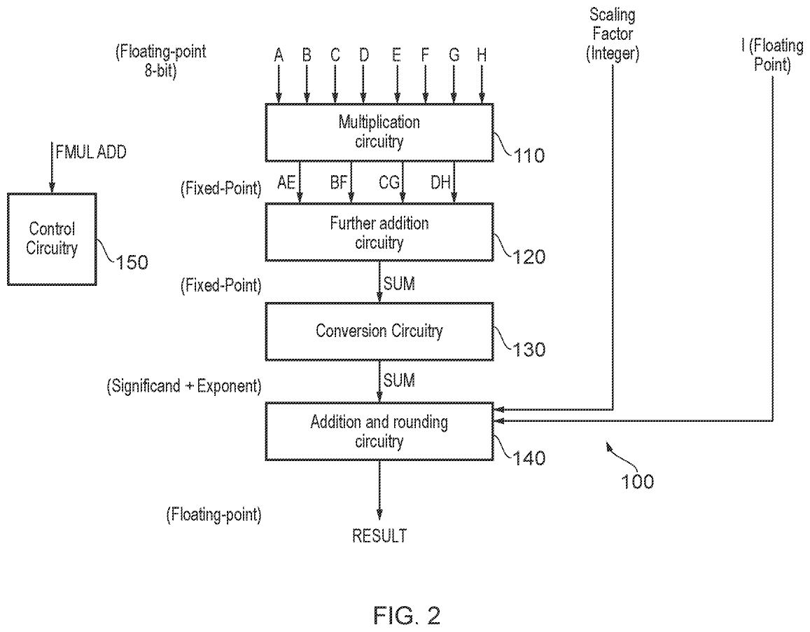

FIG. 2 illustrates, schematically, circuitry for performing the fused multiply add operation shown with respect to FIG. 1. In this example, the four 8-bit floating-point numbers stored in register r1 (A, B, C, D) are provided as inputs to multiplication circuitry 110 together with the four 8-bit floating-point numbers stored in register r2 (E, F, G, H).

The multiplication circuitry 110 performs the product as previously shown in FIG. 1. That is, it produces the products AE, BF, CG, and DH. In this example, as well as performing the multiplication, the result is put into a fixed-point format.

The four products are then added together using the further addition circuitry 120 to form a sum. The resulting sum is again in a fixed-point format and conversion circuitry 130 is used to convert the sum into a significand and an exponent (for instance, in the form of a floating-point number).

This sum is added to the accumulation parameter I (which is in a floating-point format) using addition and rounding circuitry 140. The addition and rounding circuitry 120 also takes a scaling factor as an input. The scaling factor indicates how each the sum of the products is to be scaled thereby allowing larger or smaller than normal 8-bit floating-point numbers to be expressed. By passing the scaling factor into the further addition circuitry 120, the sum of the products can be adjusted appropriately.

The addition and rounding circuitry 140 also performs the rounding operation on the resulting addition to produce an end result. As previously explained, this is the only time in the process that rounding is performed and consequently accuracy can be preserved throughout the process. That is, there is no loss of accuracy between the inputs being provided until the rounding process in the addition and rounding circuitry 140. The final result is provided in floating-point format.

In these examples, once data has passed into the addition and rounding circuitry 140, it is possible for a new set of data to be received by the multiplication circuitry. This allows for a ‘pipelining’ of operations in which a second operation in a sequence of operations begins execution before the first operation has completed. This is possible, at least in part, because the parameter ‘I’ is not used until the addition and rounding circuitry 140 and so the data to be operated on need not actually be provided until that time.

FIG. 2 also shows the control circuitry 150, which is responsible for responding to an incoming FMULADD instruction. For instance, the control circuitry may acquire the relevant operands (A . . . I) from the parameters of the instruction, as well as controlling any input of the operation (e.g. the result) and controlling the multiplication circuitry 110, addition and rounding circuitry 140, and further addition circuitry 120 to perform the necessary operations. The control circuitry could, for instance, take the form of decode circuitry in a conventional pipeline, which generates appropriate control signals to acquire data and for that data to be passed on to functional units (e.g. the addition and rounding and multiplication circuitry) to perform the operation on that data.

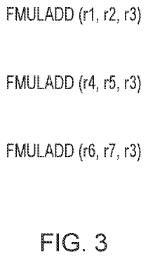

FIG. 3 illustrates a chaining of fused multiply add instructions that can be used to multiply numerous sets of numbers together and then add all the products. In particular, a first instruction performs a set of product between the values of r1 and r2 and then adds those products to the values in r3. A second instruction performs a set of products between the values of r4 and r5, and then adds those products to the value in r3. A third instruction performs a set of products between the values of r6 and r7, and then adds those products to the value in r3.

As previously explained, a pipelining of these instructions is possible. That is, while the addition part of the instruction FMULADD(r1, r2, r3) is being performed, the multiplication part of the instruction FMULADD(r4, r5, r3) can be performed. The parameter r3 is only used during the addition part of the operation and so is not overloaded during this process.

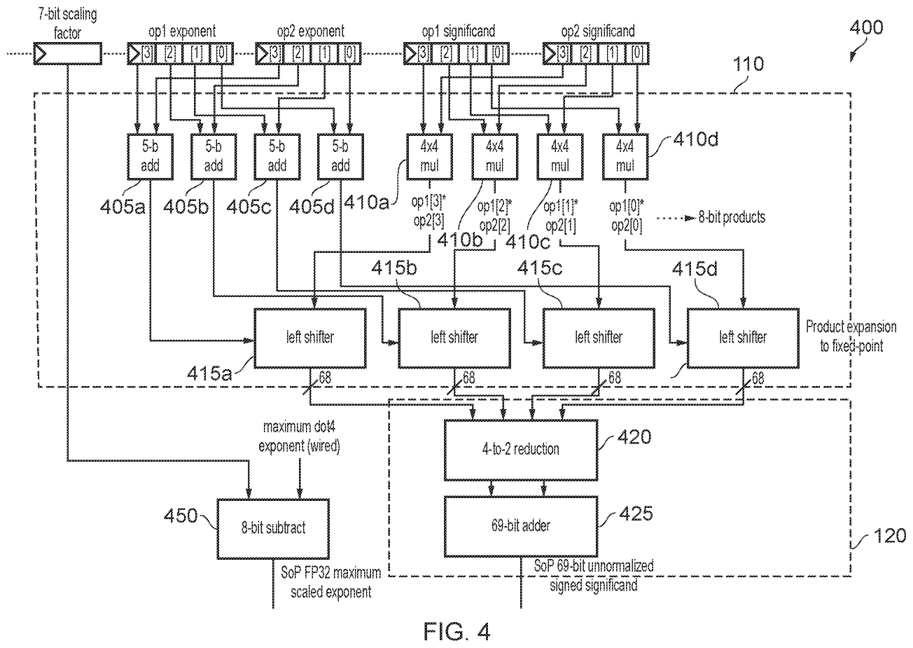

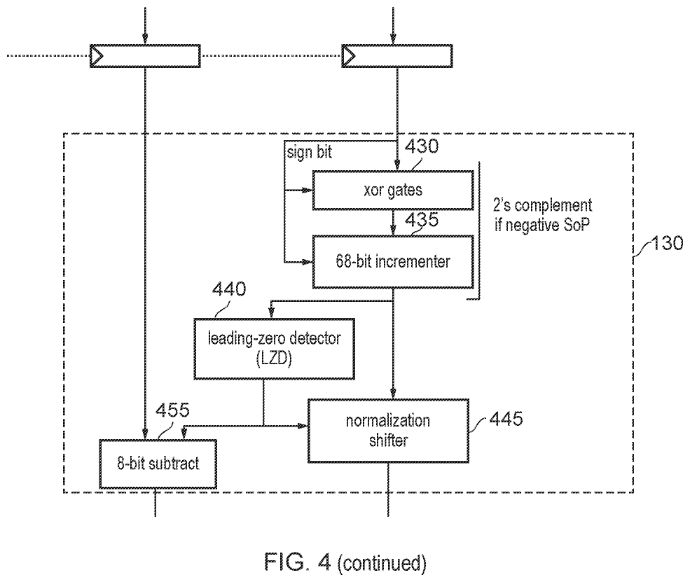

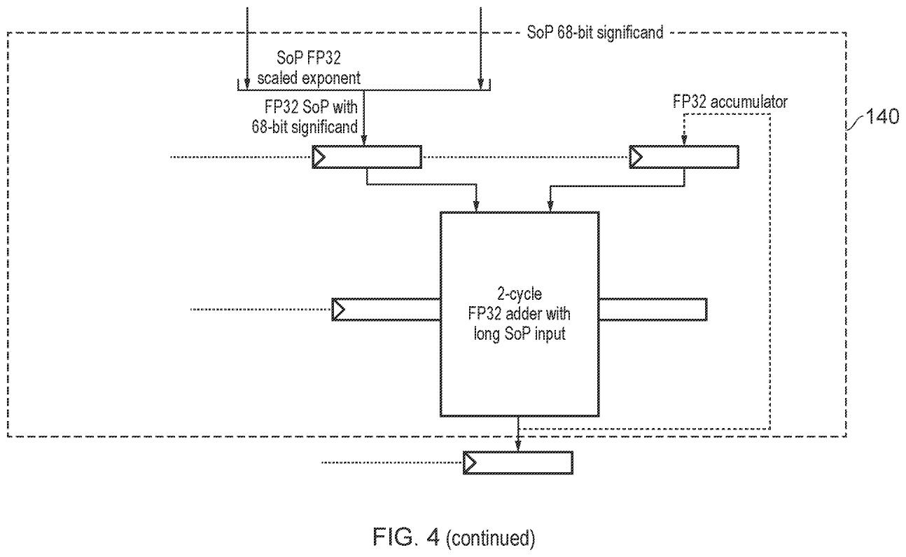

FIG. 4 shows a detailed layout of circuitry 400 for performing the fused multiply add operation that was schematically illustrated in FIG. 2. The initially provided parameters include op1 exponent (four exponents from a first set of 8-bit floating-point numbers), op2 exponent (four exponents from a second set of 8-bit floating-point numbers), op1 significand (four significands from the first set of 8-bit floating-point numbers), op2 significand (four significands from the second set of 8-bit floating-point numbers), and a 7-bit scaling factor.

Note that the exact format of the 8-bit floating point numbers is not relevant in this example, provided the exponents and significands can be accessed separately. Note also that the manner in which the significands and exponents are provided is also not relevant. For instance, all the exponents might be provided together and all of the significands might be provided separately (but together with each other) as shown in FIG. 2. Alternately, the first set of four 8-bit floating-point numbers might be provided together and the second set of four 8-bit floating-point numbers might be separately provided (together with each other). It is merely a case of wiring to ensure that the exponents and significands are accessed together in the correct pairs. Note also in this example that 8-bit floating-point numbers are provided. However, other floating-point numbers might also be provided in pairs. The number of pairs is also variable and the scaling factor is also arbitrarily changeable.

The exponents belonging to pairs of floating-point numbers that are to be multiplied together are added together using (in this example) 5-bit adders 405a, 405b, 405c, 405d.

In parallel to this, the significands belonging to pairs of floating-point numbers that are to be multiplied together are multiplied together using (in this example) 4×4 multipliers to produce 8-bit products.

The outputs from the adders 405a, 405b, 405c, 405d then dictate how much of a left shift to perform on the multiplied significands produced from the 4×4 multipliers 410a, 410b, 410c, 410d. This left shifting is performed using left shifters 415a, 415b, 415c, 415d. The output from the left shifters 415a, 415b, 415c, 415d (and therefore the multiplication circuitry 110) is therefore a set of fixed-point products. The products may be performed in redundant representation, although this is not essential

These products are provided to the further addition circuitry 120, which performs an addition of the products to produce a fixed-point sum in non-redundant representation. This is achieved using a 4-to-2 reduction carry-save-adder (CSA) network 420 and an adder 425 to convert the result to non-redundant representation

The conversion circuitry 130 then takes care of converting the significand into a format suitable for floating-point representation. In particular, the sign bit from the resulting sum is determined, and this is used with a combination of XOR gates 430 and an incrementer 435 to convert the result into twos complement (if the number is to be negative). A leading zero detector (LZD) 440 is then used together with a shifter 445 to normalize the result so that it is suitable for floating point format. Recall that a normalized floating-point number has a significand with a single digit to the left of the decimal point, so the normalization process might involve moving the decimal point (and thereby adjusting the exponent) to normalize the sum.

The sum (in the form of a separate significand and exponent in this example) are provided to addition and rounding circuitry 140. The circuitry adds the sum to the accumulator and rounds the result. The result is then output and may be provided back to the accumulator.

Some adjustments to the scaling factor are also made during this process. As will be recalled, the scaling factor is used to provide a scaling to the sum of products. Firstly, a subtraction is performed using first subtraction circuitry 450 with the maximum exponent that can be achieved via the 5-bit adders 405a, 405b, 405c, 405d. The result is then adjusted as a result of the previously described normalization that occurs at the LZD 440 and normalization shifter 445. In particular, if there are many leading zeros, then the number must be made smaller through normalization and so the exponent is decreased by a corresponding amount by second subtraction circuitry 455. The result of this is provided as a scaled exponent to the addition and rounding circuitry 140 to make up the exponent of the result.

Consequently, it can be seen how a fused-multiply add operation can be performed in order to add pairs of products of floating-point numbers to an accumulator, with the accumulator only provided at a late state so that multiple operations can be processed efficiently.

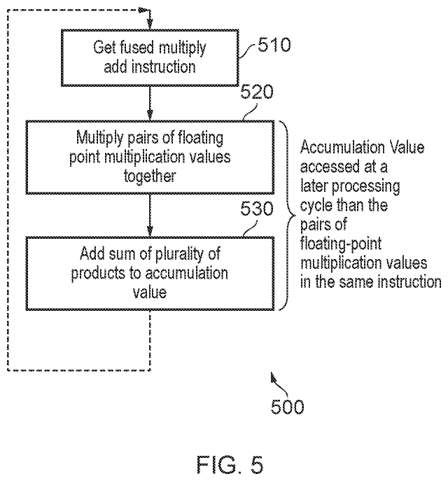

FIG. 5 shows a method of data processing in accordance with some examples in the form of a flowchart 500. The process begins at step 510 where a fused multiply add operation is received. Then, at step 520, pairs of floating-point multiplication values are multiplied together (e.g. in the form of a dot product). Then, at step 530 the resulting products are added to an accumulation value. Through this, the accumulation value is accessed at a later processing cycle than the multiplication values are accessed.

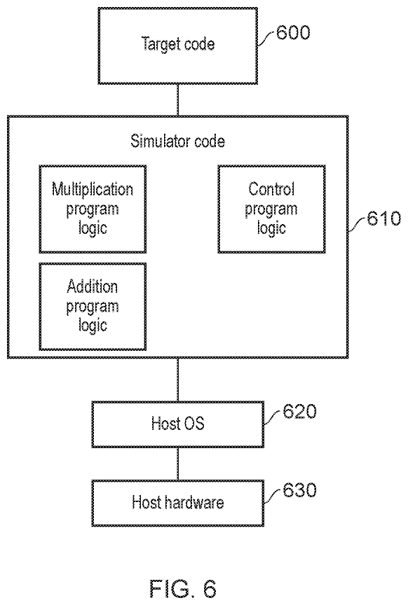

FIG. 6 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 630, optionally running a host operating system 620, supporting the simulator program 610. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 630), some simulated embodiments may make use of the host hardware, where suitable.

The simulator program 610 may be stored on a computer-readable storage medium (which may be a non-transitory medium), and provides a program interface (instruction execution environment) to the target code 600 (which may include applications, operating systems and a hypervisor) which is the same as the interface of the hardware architecture being modelled by the simulator program 610. Thus, the program instructions of the target code 600 may be executed from within the instruction execution environment using the simulator program 610, so that a host computer 630 which does not actually have the hardware features of the apparatus 100 discussed above can emulate these features.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A data processing apparatus for performing a fused multiply add operation, the data processing apparatus comprising:
multiplication circuitry configured to multiply pairs of floating-point multiplication values together to produce a plurality of unrounded products;
addition circuitry configured to add a sum of the plurality of products to an accumulation value to produce a rounded floating-point result; and
control circuitry responsive to a fused multiply add instruction to control the multiplication circuitry and the addition circuitry to perform the fused multiply add operation, wherein
the addition circuitry is configured to access the accumulation value at a later processing cycle than the multiplication circuitry accesses the pairs of floating-point multiplication values.

2. The data processing apparatus according to claim 1, wherein
the addition circuitry is controlled by the control circuitry to commence processing of the accumulation parameter after the multiplication circuitry has generated the plurality of unrounded products.

3. The data processing apparatus according to claim 1, wherein
the unrounded products are fixed-point unrounded products.

4. The data processing apparatus according to claim 1, wherein
the accumulation value is a floating-point accumulation value.

5. The data processing apparatus according to claim 1, wherein
the addition circuitry is configured to perform the addition using a scaling factor that indicates how the sum of the plurality of products is to be scaled.

6. The apparatus according to claim 1, wherein
the fused multiply add instruction is one of a sequence of instructions and the accumulation value is a value generated in response to a preceding instruction in said sequence of instructions.

7. The apparatus according to claim 6, wherein
the preceding instruction is a preceding fused multiply add instruction.

8. The apparatus according to claim 1, comprising:
further addition circuitry configured to add the plurality of unrounded products together to generate the sum of the plurality of products.

9. The apparatus according to claim 8, wherein
the addition circuitry is controlled by the control circuitry to commence processing of the accumulation parameter after the further addition circuitry has generated the sum of the plurality of products.

10. The apparatus according to claim 8, wherein
the sum of the plurality of products output by the further addition circuitry is a fixed-point number.

11. The apparatus according to claim 10, wherein
the sum of the plurality of products is generated without loss of accuracy.

12. The apparatus according to claim 1, wherein
the control circuitry is responsive to a sequence of fused multiply add instructions comprising a first fused multiply add instruction and a second fused multiply add instruction to control the multiplication circuitry and the addition circuitry such that the adding circuitry performs an add operation in response to the first fused multiply add instruction in parallel with the multiplication circuitry performing a multiply operation in response to the second fused multiply add instruction.

13. The apparatus according to claim 1, wherein
each of the floating-point multiplication values has a width of 8 bits.

14. The apparatus according to claim 1, wherein
the multiplication circuitry is configured to multiply four pairs of floating-point multiplication values.

15. A method of performing a fused multiply add operation comprising:
multiplying pairs of floating-point multiplication values together to produce a plurality of unrounded products;
adding a sum of the plurality of products to an accumulation value to produce a rounded floating-point result; and
responding to a fused multiply add instruction to control multiplication circuitry and addition circuitry to perform the fused multiply add operation, wherein
the accumulation value is accessed at a later processing cycle than the pairs of floating-point multiplication values.

16. A computer program for controlling a host data processing apparatus to provide an instruction execution environment, the computer program comprising:
multiplication program logic configured to multiply pairs of floating-point multiplication values together to produce a plurality of unrounded products;
addition program logic configured to add a sum of the plurality of products to an accumulation value to produce a rounded floating-point result; and
control program logic responsive to a fused multiply add instruction to control the multiplication program logic and the addition program logic to perform the fused multiply add operation, wherein
the addition program logic is configured to access the accumulation value at a later processing cycle than the multiplication program logic accesses the pairs of floating-point multiplication values.
